(19) United States
(12) Patent Application Publication
(10) Pub. No.: US 2024/0346460 A1
(43) Pub. Date: Oct. 17, 2024

(54) MAINTENANCE RESPONSE TIME PROPOSAL APPARATUS, METHOD AND PROGRAM

(71) Applicant: Nippon Telegraph and Telephone Corporation, Tokyo (JP)

(72) Inventors: Yuichiro ISHIZUKA, Musashino-shi, Tokyo (JP); Kei TAKESHITA, Musashino-shi, Tokyo (JP); Yuji SOEJIMA, Musashino-shi, Tokyo (JP)

(21) Appl. No.: 18/681,589

(22) PCT Filed: Aug. 6, 2021
(86) PCT No.: PCT/JP2021/029354

§ 371 Date: Feb. 6, 2024

(51) Int. Cl. G06Q 10/20

(52) U.S. Cl. CPC G06Q 10/20

(57) ABSTRACT

A maintenance response time suggestion device 1 suggests a response time for preventive maintenance against malfunction of a device. The device 1 includes: a sign receiving unit 11 that receives sign detection information in which a sign of malfunction of the device is detected; a resource receiving unit 14 that receives resource utilization plan information that indicates a plan for a usage and a utilization time of human and physical resources related to a predicted occurrence period of the malfunction of the device; a resource estimation unit 15 that estimates and calculates transition data of a usage amount of the human and physical resources related to the predicted occurrence period of the malfunction of the device by inputting the usage and the utilization time of the human and physical resources included in the resource utilization plan information to a machine learning engine that generates transition data of a usage amount of human and physical resources based on a usage and a utilization period of human and physical resources and performing machine learning; and a countermeasure determination unit 17 that determines a time and a method for taking countermeasures against the malfunction of the device based on the sign detection information and the transition data of the usage amount of the human and physical resources.

### TECHNICAL FIELD

The present invention relates to a maintenance response time suggestion device, a maintenance response time suggestion method, and a maintenance response time suggestion program.

### BACKGROUND ART

Some devices on a network, such as servers, routers, and switches, are equipped with a function of acquiring and transmitting a detailed internal device state in real-time based on techniques such as telemetry used to monitor and manage network infrastructure. A network supervisor or administer can see signs of failure and the like, and execute preventive maintenance for the device by obtaining a detailed internal device state using this function.

It is desirable to execute the preventive maintenance at a convenient time when human and physical resources are available, rather than immediately taking countermeasures against the signs of failure of the device or the like. In other words, preventive maintenance of the device should be executed at a time when there is little planned use of human and physical resources. Therefore, a scheduling support technique for efficiently allocating human resources based on given conditions is known (NPL 1).

### CITATION LIST

### Non Patent Literature

[NPL 1] Chen, et al., “Proposal of Support Method for Planning Operation by use of Gantt charts and RPA,” 2020 National Conference on Management Information, Nov. 7 to 8, 2020, pages 148-151, [online], [retrieved Jul. 15, 2021], Internet <URL: https://www.jstage.jst.go.jp/article/jasmin/202011/0/202011_148/_pdf/-char/ja>

### SUMMARY OF INVENTION

### Technical Problem

However, NPL 1 is merely a technique for allocating human resources, and the task of estimating the usage amount of human resources, which is a premise thereof, must be performed manually. Therefore, it is not possible to completely automate the preparation of the execution plan for preventive maintenance of the device.

The present invention has been made in view of the above circumstances, and an object of the present invention is to provide a technique through which an execution plan for preventive maintenance of a device against signs of device malfunction such as failures or faults can be automatically formulated without human intervention.

### Solution to Problem

A maintenance response time suggestion device according to one aspect of the present invention is a maintenance response time suggestion device that suggests a response time for preventive maintenance against malfunction of a device, the maintenance response time suggestion device including: a sign receiving unit that receives sign detection information in which a sign of malfunction of the device is detected; a resource receiving unit that receives resource utilization plan information that indicates a plan for a usage and a utilization time of human and physical resources related to a predicted occurrence period of the malfunction of the device; a resource estimation unit that estimates and calculates transition data of a usage amount of the human and physical resources related to the predicted occurrence period of the malfunction of the device by inputting the usage and the utilization time of the human and physical resources included in the resource utilization plan information to a machine learning engine that generates transition data of a usage amount of human and physical resources based on a usage and a utilization period of human and physical resources and performing machine learning; and a countermeasure determination unit that determines a time and a method for taking countermeasures against the malfunction of the device based on the sign detection information and the transition data of the usage amount of the human and physical resources.

A maintenance response time suggestion method according to one aspect of the present invention is a maintenance response time suggestion method for suggesting a response time for preventive maintenance against malfunction of a device, the method causing a maintenance response time suggestion device to execute: receiving sign detection information in which a sign of malfunction of the device is detected; receiving resource utilization plan information that indicates a plan for a usage and a utilization time of human and physical resources related to a predicted occurrence period of the malfunction of the device; estimating and calculating transition data of a usage amount of the human and physical resources related to the predicted occurrence period of the malfunction of the device by inputting the usage and the utilization time of the human and physical resources included in the resource utilization plan information to a machine learning engine that generates transition data of a usage amount of human and physical resources based on a usage and a utilization period of human and physical resources and performing machine learning; and determining a time and a method for taking countermeasures against the malfunction of the device based on the sign detection information and the transition data of the usage amount of the human and physical resources.

A maintenance response time suggestion program according to one aspect of the present invention causes a computer to function as the maintenance response time suggestion device.

### Advantageous Effects of Invention

According to the present invention, it is possible to provide a technique through which an execution plan for preventive maintenance of a device against signs of device malfunction such as failures or faults can be automatically formulated without human intervention.

### BRIEF DESCRIPTION OF DRAWINGS

FIG. 1 is a diagram showing a functional block configuration of a maintenance response time suggestion device.

FIG. 2 is a diagram showing an example of transition data of a risk level and an example of transition data of a usage amount of human and physical resource.

FIG. 3 is a diagram showing a processing flow of a maintenance response time suggestion device.

FIG. 4 is a diagram showing an example of sign detection information.

FIG. 5 is a diagram showing an example of sign-related information.

FIG. 6 is a diagram showing an example of risk level transition data.

FIG. 7 is a diagram showing an example of resource utilization plan information.

FIG. 8 is a diagram showing an example of transition data of a usage amount of human and physical resources.

FIG. 9 is a diagram showing an example of risk level transition data, an example of resource utilization plan information, and an example of difference transition data.

FIG. 10 is a diagram showing an example of a recommended countermeasure time and a recommended countermeasure method.

FIG. 11 is a diagram showing an example of resource usage transition patterns for each keyword.

FIG. 12 is a diagram showing a hardware configuration of a maintenance response time suggestion device.

### DESCRIPTION OF EMBODIMENTS

Embodiments of the present invention will be described below with reference to the drawings. In the description provided with reference to the drawings, the same parts are denoted by the same reference numerals and the description thereof is omitted.

### [Maintenance Response Time Suggestion Device]

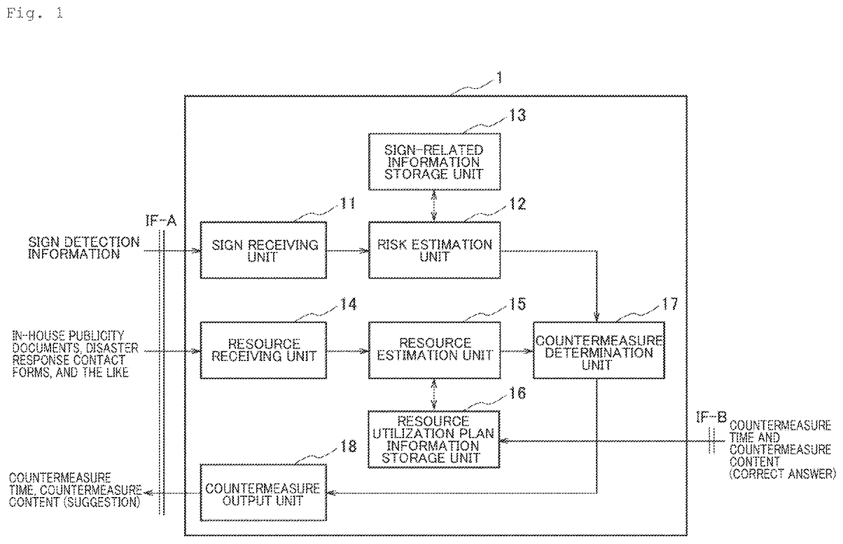

FIG. 1 is a diagram showing a functional block configuration of a maintenance response time suggestion device 1 according to the present embodiment. The maintenance response time suggestion device 1 is a computer that suggests a response time and a response method for preventive maintenance for a device on a network, such as a server, a router, or a switch (hereinafter referred to as an NW device), against signs of malfunction of the NW device. The malfunction is, for example, a failure or a fault of the NW device.

### [Outline of Operation of Maintenance Response Time Suggestion Device]

In order to suggest the response time and response method for preventive maintenance of the NW device, the maintenance response time suggestion device 1 receives sign detection information in which a sign of malfunction of the NW device is detected and resource utilization plan information indicating a plan for a usage and a utilization time of human and physical resources related to a predicted occurrence period of the malfunction of the NW device.

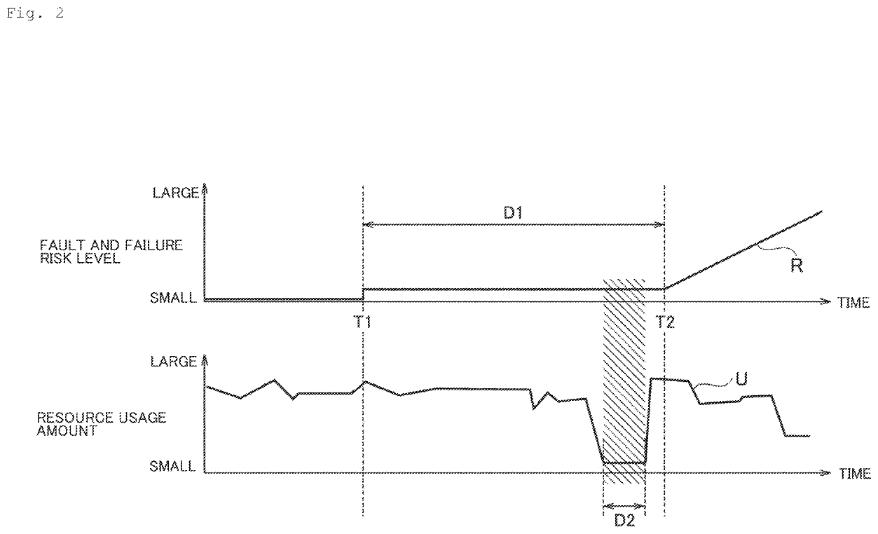

Then, as shown in FIG. 2, the maintenance response time suggestion device 1 estimates and calculates the transition data R of a risk level due to the malfunction of the NW device based on the sign detection information and estimates and calculates the transition data U of a usage amount of human and physical resources based on the resource utilization plan information.

After that, the maintenance response time suggestion device 1 suggests a predicted malfunction occurrence period D1 from a sign detection time T1 to a predicted malfunction occurrence time T2 and a period D2 before and after the period D1, in which there is a margin in the usage amount of human and physical resources as a response time for preventive maintenance of the NW device based on difference transition data (not shown) obtained by subtracting the transition data U of the usage amount of human and physical resources from the transition data R of the risk level.

In particular, in the present embodiment, when estimating and calculating the transition data U of the usage amount of the human and physical resources, the maintenance response time suggestion device 1 uses a machine learning engine that generates transition data of a usage amount of human and physical resources based on a usage and a utilization period of human and physical resources. The maintenance response time suggestion device 1 estimates and calculates the transition data U of the usage amount of the human and physical resources related to the predicted malfunction occurrence period D1 by inputting the usage and the utilization time of the human and physical resources included in the input resource utilization plan information to the machine learning engine and performing machine learning.

In addition, in the present embodiment, the maintenance response time suggestion device 1 updates a variation parameter of a pattern shape of the transition data of the usage amount of the human and physical resources by inputting the usage and the utilization time of the human and physical resources included in each of a plurality of pieces of resource utilization plan information to the machine learning engine and performing machine learning so that a difference between the determined time to take countermeasures against the malfunction of the NW device and a time to take countermeasures determined by a person decreases.

In this way, the maintenance response time suggestion device 1 uses a machine learning engine to estimate and calculate the transition data U of the usage amount of human and physical resources. Therefore, it is possible to provide a technique through which an execution plan for preventive maintenance of an NW device against a sign of malfunction of the NW device such as a failure or a fault can be appropriately formulated automatically without human intervention.

In addition, the maintenance response time suggestion device 1 repeats the machine learning of the machine learning engine so that the difference between the determined time to take countermeasures against the malfunction of the NW device and the time to take countermeasures determined by a person decreases. Therefore, it is possible to provide a technique through which an execution plan for preventive maintenance of the NW device can be appropriately formulated.

Furthermore, the maintenance response time suggestion device 1 suggests the period D2 in which there is a margin in the usage amount of human and physical resources as the response time for preventive maintenance of the NW device. Therefore, it is possible to provide a technique through which an execution plan for preventive maintenance of the NW device can be appropriately formulated.

### [Configuration of Maintenance Response Time Suggestion Device]

In order to execute the above-described outline operation and realize the effects, as shown in FIG. 1, the maintenance response time suggestion device 1 includes, for example, a sign receiving unit 11, a risk estimation unit 12, a sign-related information storage unit 13, a resource receiving unit 14, a resource estimation unit 15, a resource utilization plan information storage unit 16, a countermeasure determination unit 17, and a countermeasure output unit 18. IF-A is an interface used during operation of the maintenance response time suggestion device 1. IF-B is an interface used during learning of the machine learning engine.

The sign receiving unit 11 has a function of receiving sign detection information in which a sign of malfunction of the NW device is detected. For example, the sign receiving unit 11 acquires, from an operation system (OpS) (not shown) or a sign detection device (not shown), sign detection information received by the OpS or the sign detection device from the NW device. The sign detection information includes, for example, the name of the NW device with the sign of malfunction, the installation location of the NW device, the date and time of sign detection, the sign name, and the like.

The risk estimation unit 12 has a function of estimating and calculating the transition data of the risk level due to the malfunction of the NW device using the sign-related information set in advance in the sign-related information storage unit 13 by an operator or the like based on the sign detection information.

The sign-related information storage unit 13 has a function of storing sign-related information set in advance by the operator or the like. The sign-related information includes, for example, the name of the sign, an effective countermeasure method for the malfunction of the NW device with the sign, and a delay from the sign detection time to the malfunction occurrence time.

The resource receiving unit 14 has a function of receiving resource utilization plan information indicating a plan for a usage and a utilization time of human and physical resources related to the predicted occurrence period the malfunction of the NW device. For example, the resource receiving unit 14 acquires in-house publicity information stored in an in-house publicity information management device (not shown) from the in-house publicity information management device. The in-house publicity information states that a predetermined event (=usage of human and physical resources) will be held from month OO day xx to month OO day zz.

In addition to the in-house publicity information, for example, the resource receiving unit 14 acquires a disaster response contact form from a disaster countermeasure transmission tool or the like (not shown). The disaster response contact form states that countermeasures against an earthquake disaster (=usage of human and physical resources) will be performed from month □□ to month ⋄⋄. In addition, the resource utilization plan information includes information on depletion of materials due to end of life (EoL), information on depletion of human resources due to ongoing events, and the like.

The resource estimation unit 15 has a function of estimating and calculating transition data of a usage amount of the human and physical resources related to the predicted occurrence period of the malfunction of the NW device by inputting the usage and the utilization time of the human and physical resources included in the resource utilization plan information to a machine learning engine that generates transition data of a usage amount of human and physical resources based on a usage and a utilization period of human and physical resources and performing machine learning.

In addition, the resource estimation unit 15 has a function of updating a variation parameter that forms a pattern shape of the transition data of the usage amount of the human and physical resources by inputting the usage and the utilization time of the human and physical resources included in each of a plurality of pieces of resource utilization plan information to the machine learning engine and performing machine learning repeatedly. The variation parameter is, for example, a rising period, a convergence period, and a maximum value of the usage amount of human and physical resources.

Further, the resource estimation unit 15 has a function of updating the variation parameter more appropriately by repeating the machine learning of the machine learning engine so that a difference between the time to take countermeasures against the malfunction of the NW device determined by the maintenance response time suggestion device 1 and a time to take countermeasures determined by a person decreases.

The resource utilization plan information storage unit 16 has a function of storing various pieces of data used, for example, when the machine learning engine estimates and calculates the transition data of the usage amount of the human and physical resources and when performing machine learning. For example, the resource utilization plan information storage unit 16 stores the usage and the utilization time of the human and physical resources included in the resource utilization plan information, the variation parameter, the time to take countermeasures (teacher data of machine learning: correct answer) determined by a person input from an operator terminal (not shown), and the like.

The countermeasure determination unit 17 has a function of determining a time and a method for taking countermeasures against the malfunction of the NW device within a period included in the predicted occurrence period of the malfunction of the NW device or a period before or after the period based on the sign detection information, the transition data of the usage amount of the human and physical resources. Specifically, the countermeasure determination unit 17 obtains difference transition data by subtracting the transition data of the usage amount of human and physical resources from the transition data of the risk level estimated and calculated based on the sign detection information, and determines a time at which a value of the difference transition data matches a threshold of a predetermined countermeasure method for an index of the difference as a countermeasure time of the predetermined countermeasure method.

The predetermined countermeasure method includes, for example, remote measures such as remote resetting, local measures such as plugging and unplugging cables without on-site exchange of parts, local exchange such as on-site exchange of parts, and doing nothing.

The countermeasure output unit 18 has a function of outputting the time and method for taking countermeasures determined for the malfunction of the NW device as a recommended countermeasure time and a recommended countermeasure method. For example, the countermeasure output unit 18 displays the determined time and method for taking countermeasures on the screen of the operator terminal or the like.

### [Processing Operation of Maintenance Response Time Suggestion Device]

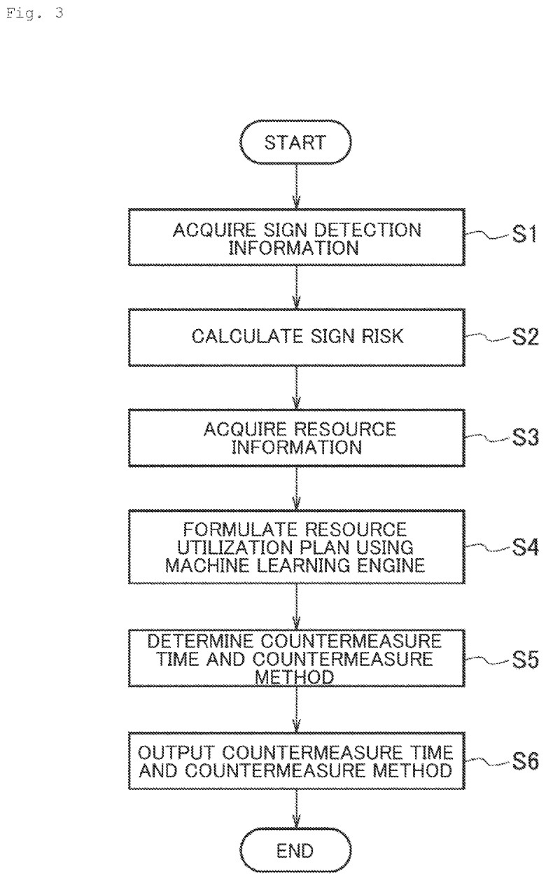

FIG. 3 is a diagram showing a processing flow of the maintenance response time suggestion device 1.

### Step S1:

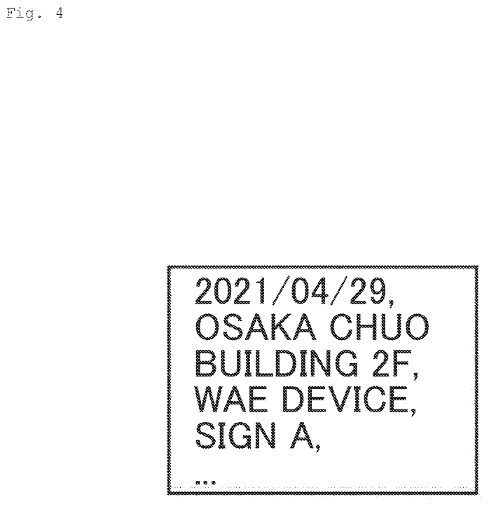

First, the sign receiving unit 11 receives the sign detection information in FIG. 4 in which the sign of malfunction of the NW device is detected. The sign detection information includes, for example, the name of the NW device with the sign of a fault, the installation location of the NW device, the date and time of sign detection, the sign name, and the like.

### Step S2:

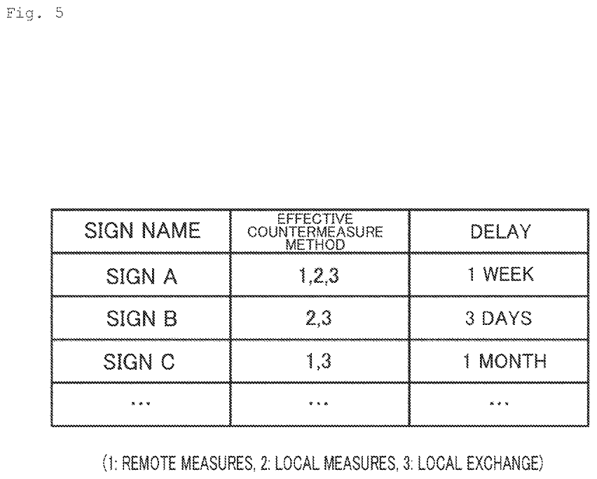

Next, the risk estimation unit 12 acquires an effective countermeasure method and a delay corresponding to the sign name in the sign detection information from the sign-related information of FIG. 5 stored in the sign-related information storage unit 13, and estimates and calculates the transition data of the risk level due to the fault of the NW device based on the sign detection date and time in the sign detection information, the effective countermeasure method, and the delay.

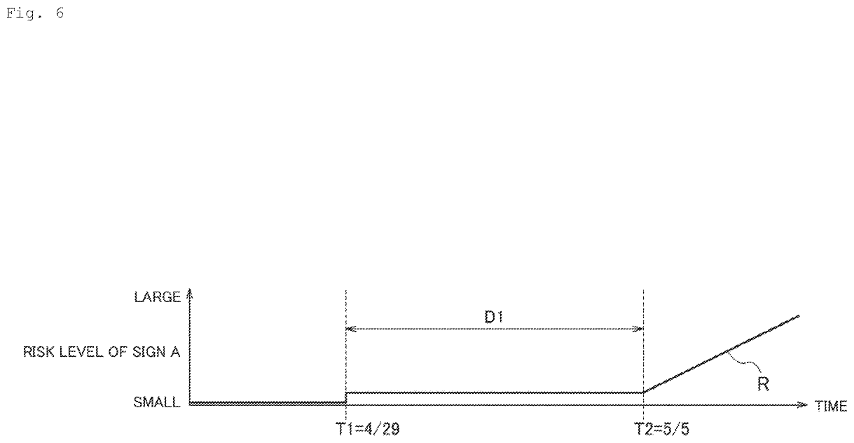

For example, as shown in FIG. 6, the risk estimation unit 12 sets the sign detection date and time as the sign detection time T1, sets the time obtained by adding the delay to the sign detection time T1 as the predicted fault occurrence time T2 of the NW device, sets a period from T1 to T2 as a predicted fault occurrence period D1 of the NW device, and outputs transition data R having a risk level corresponding the sign name.

Note that the risk estimation unit 12 stores risk levels over time different depending on the sign name in advance. For example, a risk level that rises sharply in a short period of time is stored for sign A, and a risk level that rises slowly over a long period of time is stored for sign B.

### Step S3:

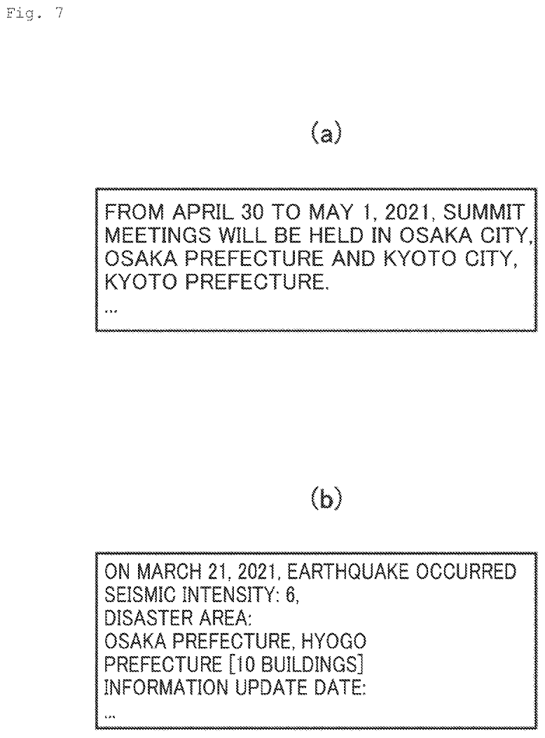

Next, the resource receiving unit 14 receives a plurality of pieces of resource utilization plan information indicating the plans for a usage and a utilization time of the human and physical resources related to the predicted fault occurrence period D1 of the NW device. For example, the resource receiving unit 14 receives the publicity information in FIG. 7(a) and the disaster response contact form in FIG. 7(b).

### Step S4:

Next, the resource estimation unit 15 formulates a utilization plan for the human and physical resources related to the predicted fault occurrence period D1 of the NW device based on the usage and the utilization time of the human and physical resources included in the plurality of pieces of resource utilization plan information. Specifically, the resource estimation unit 15 estimates and calculates the transition data of the usage amount of the human and physical resources related to the predicted fault occurrence period D1 of the NW device by inputting the usage and the utilization time of the human and physical resources included in the plurality of pieces of resource utilization plan information to the machine learning engine and performing machine learning.

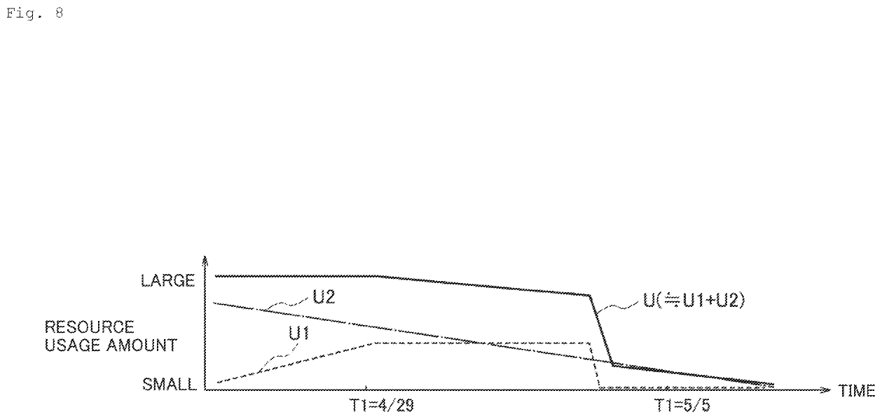

As an image of the estimation and calculation, as shown in FIG. 8, transition data U is created by summing the transition data U1 of the usage amount of the human and physical resources required for the usage of the publicity information of FIG. 7(a) and the transition data U2 of the usage amount of the human and physical resources required for the usage of the disaster response contact form of FIG. 7(b).

### Step S5:

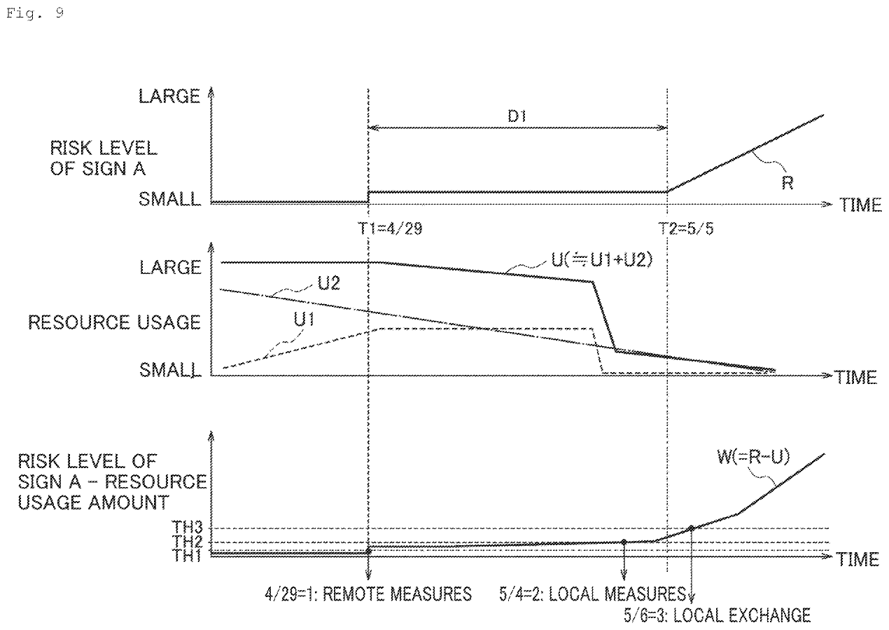

Next, as shown in FIG. 9, the countermeasure determination unit 17 obtains difference transition data W obtained by subtracting the transition data U of the usage amount of human and physical resources obtained in step S4 from the transition data R of the risk level obtained in step S2. After that, the countermeasure determination unit 17 determines that the countermeasure method will be performed when the difference transition data W exceeds a threshold TH of the effective countermeasure method acquired in step S2 (threshold determined in advance for the index of the difference).

At this time, the countermeasure determination unit 17 selects only the countermeasure time included in the predicted fault occurrence period D1 of the NW device. However, the predicted fault occurrence time T2, which is the final time of the predicted fault occurrence period D1, is just the prediction time estimated by the maintenance response time suggestion device 1 itself, and there is a possibility that the fault will not occur even after T2. Therefore, a countermeasure time included in the period after T2 may be selected.

### Step S6:

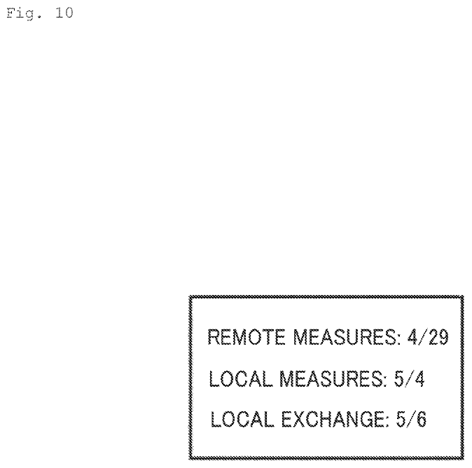

Finally, the countermeasure output unit 18 outputs the time and method for taking countermeasures determined for the fault of the NW device as a recommended countermeasure time and a recommended countermeasure method. For example, the countermeasure output unit 18 outputs the recommended countermeasure time and recommended countermeasure method shown in FIG. 10.

### [Machine Learning of Machine Learning Engine]

When using the machine learning engine in step S4, the resource estimation unit 15 updates the variation parameter that forms the pattern shape of the transition data of the usage amount of the human and physical resources many times by inputting the usage and the utilization time of the human and physical resources included in each of a plurality of pieces of resource utilization plan information to the machine learning engine and repeating the machine learning.

However, even if resource information with a high degree of freedom, such as in-house publicity documents and disaster response contact forms, is input to the maintenance response time suggestion device 1 and the internal parameters of an intermediate layer updated by machine learning are set blindly, there is a possibility that the determination accuracy of the countermeasure time will not improve.

Therefore, in the present embodiment, the accuracy of machine learning is improved by feeding back the determination results of the countermeasure time made by a person. Specifically, when the machine learning engine performs learning, the countermeasure time when countermeasures are to be taken, actually determined by a person is taken in as teacher data (correct answer) and the machine learning engine is improved so as to output a time close to the countermeasure time. In this way, it is possible to output a highly accurate countermeasure time.

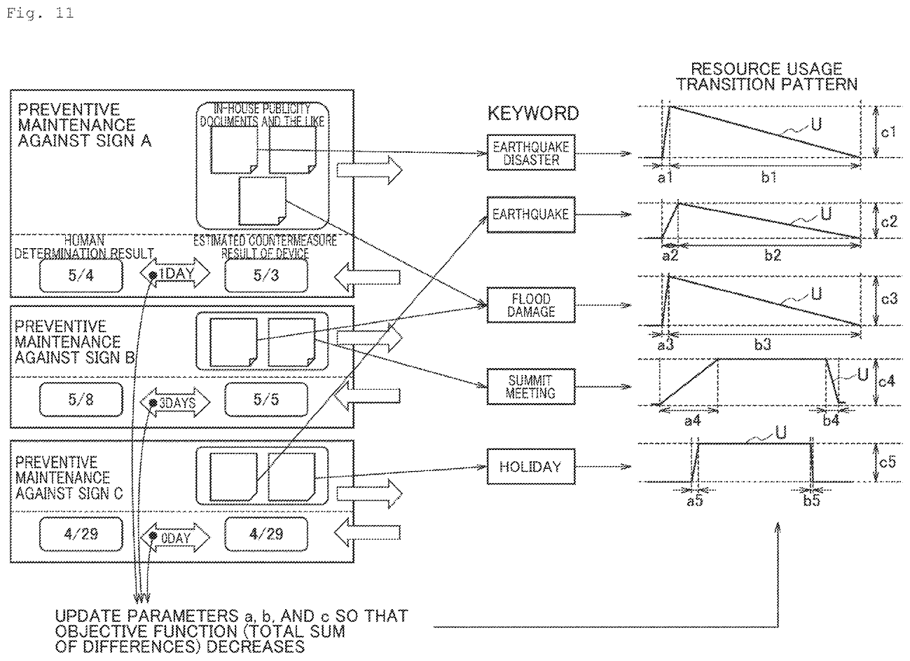

Specifically, as shown in FIG. 11, the resource estimation unit 15 generates a pattern of the transition data of the resource usage amount of the human and physical resources for each usage (keywords included in in-house publicity documents) of human and physical resources. Then, the resource estimation unit 15 sets the variation parameters necessary for estimating and calculating the transition data U of the usage amount of the human and physical resources for each keyword as the internal parameters of the machine learning, that is, the rising periods a1 to a5 of the usage amount of the human and physical resources of the resource usage transition pattern (=U) corresponding to each keyword, the convergence periods b1 to b5, and the maximum values c1 to c5 of the human and physical resources to be secured and tunes the respective values of the internal parameters so that the target function, “Total sum of |(countermeasure time of correct answer)−(countermeasure time of determination result)|” decreases.

In this way, each resource usage transition pattern is updated by machine learning, so that keywords and resource usage transition patterns are gradually linked in one-to-one correspondence, whereby a highly accurate countermeasure time close to the determination result of the countermeasure time made by a person can be output.

In this way, by using the rising period a, the convergence period b, and the maximum value c of the resource usage amount as the internal parameters, meaningful machine learning based on logic is performed, whereby the accuracy of machine learning can be improved. In addition, since the initial values of the internal parameters can be input manually, the accuracy of machine learning can be improved at an early stage. Furthermore, since the resource usage transition pattern composed of the rising period a, the convergence period b, and the maximum value c of the resource usage amount is used, even if detailed resource utilization plan information is not given, the response time and the response method for the preventive maintenance can be suggested.

### Effects

According to the present embodiment, the maintenance response time suggestion device 1 includes the sign receiving unit 11 that receives sign detection information in which a sign of malfunction of the NW device is detected; the resource receiving unit 14 that receives resource utilization plan information that indicates a plan for a usage and a utilization time of human and physical resources related to a predicted occurrence period of the malfunction of the NW device; the resource estimation unit 15 that estimates and calculates transition data of a usage amount of the human and physical resources related to the predicted occurrence period of the malfunction of the NW device by inputting the usage and the utilization time of the human and physical resources included in the resource utilization plan information to a machine learning engine that generates transition data of a usage amount of human and physical resources based on a usage and a utilization period of human and physical resources and performing machine learning; and the countermeasure determination unit 17 that determines a time and a method for taking countermeasures against the malfunction of the NW device based on the sign detection information and the transition data of the usage amount of the human and physical resources. Therefore, it is possible to provide a technique through which an execution plan for preventive maintenance of a device against signs of device malfunction such as failures or faults can be automatically formulated without human intervention.

Further, according to the present embodiment, the resource estimation unit 15 updates a variation parameter of a pattern shape of the transition data of the usage amount of the human and physical resources by inputting the usage and the utilization time of the human and physical resources included in each of a plurality of pieces of resource utilization plan information to the machine learning engine and performing machine learning so that a difference between the determined time to take countermeasures against the malfunction of the NW device and a time to take countermeasures determined by a person decreases. Therefore, it is possible to provide a technique through which the accuracy of the time to take countermeasures against the malfunction of the NW device can be improved and an execution plan for preventive maintenance of the NW device can be appropriately formulated.

Furthermore, according to the present embodiment, the countermeasure determination unit 17 determines the time to take countermeasures against the malfunction of the NW device, which is included in the predicted occurrence period of the malfunction of the NW device. Therefore, it is possible to provide a technique through which the accuracy of the time to take countermeasures against the malfunction of the NW device can be further improved and an execution plan for preventive maintenance of the NW devices can be more appropriately formulated.

As a result, in the present embodiment, it is possible to supplement the information necessary for calculating the preventive maintenance execution time considering the resource state. Therefore, it can be expected that highly accurate results are obtained. Moreover, it can be expected that the learning accuracy will be improved at an early stage by making it easier to give the initial values manually. As a result, it is possible to prevent faults in NW devices equipped with means for detecting signs by telemetry analysis and the like based on ambiguous information. This will reduce the number of emergency responses, reduce the number of nighttime and holiday responses, and reduce adverse effects on customers (deterioration in communication quality and the like).

### [Others]

The present invention is not limited to the embodiments described above. The present invention can be modified in a number of ways within the scope of the gist of the present invention.

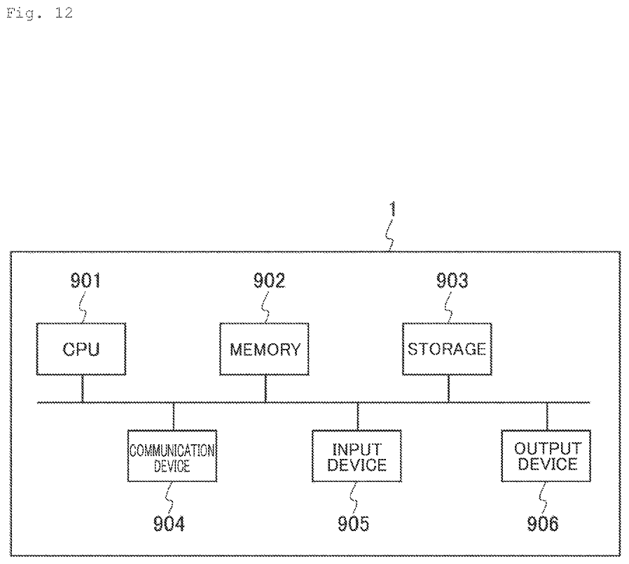

For example, as shown in FIG. 12, the maintenance response time suggestion device 1 of the present embodiment described above can be implemented using a general-usage computer system including a CPU 901, a memory 902, a storage 903, a communication device 904, an input device 905, and an output device 906. The memory 902 and the storage 903 are storage devices. In the computer system, the CPU 901 executes a predetermined program loaded on the memory 902 to realize each function of the maintenance response time suggestion device 1.

The maintenance response time suggestion device 1 may be implemented by one computer. The maintenance response time suggestion device 1 may be implemented by a plurality of computers. The maintenance response time suggestion device 1 may be a virtual machine implemented on a computer. A program for the maintenance response time suggestion device 1 can be stored in a computer-readable recording medium such as HDD, SSD, USB memory, CD, and DVD. The program for the maintenance response time suggestion device 1 can also be distributed via a communication network.

### REFERENCE SIGNS LIST

1: Maintenance response time suggestion device
11: Sign receiving unit
12: Risk estimation unit
13: Sign-related information storage unit
14: Resource receiving unit
15: Resource estimation unit
16: Resource utilization plan information storage unit
17: Countermeasure determination unit
18: Countermeasure output unit
901: CPU
902: Memory
903: Storage
904: Communication device
905: Input device
906: Output device

1. A maintenance response time suggestion device that suggests a response time for preventive maintenance against malfunction of a device, the maintenance response time suggestion device comprising one or more processors configured to perform operations comprising:
receiving sign detection information in which a sign of malfunction of the device is detected;
receiving resource utilization plan information that indicates a plan for a usage and a utilization time of human and physical resources related to a predicted occurrence period of the malfunction of the device;
estimating and calculating transition data of a usage amount of the human and physical resources related to the predicted occurrence period of the malfunction of the device by inputting the usage and the utilization time of the human and physical resources included in the resource utilization plan information to a machine learning engine that generates transition data of a usage amount of human and physical resources based on a usage and a utilization period of human and physical resources and performing machine learning; and
determining a time and a method for taking countermeasures against the malfunction of the device based on the sign detection information and the transition data of the usage amount of the human and physical resources.

2. The maintenance response time suggestion device according to claim 1, wherein the operations further comprise:
estimating and calculating transition data of a risk level due to the malfunction of the device based on the sign detection information, and
obtaining difference transition data by subtracting the transition data of the usage amount of the human and physical resources from the transition data of the risk level and determines a time at which a value of the difference transition data matches a threshold of a predetermined countermeasure method for an index of the difference as a countermeasure time of the predetermined countermeasure method.

3. The maintenance response time suggestion device according to claim 1, wherein the operations comprise:
updating a variation parameter of a pattern shape of the transition data of the usage amount of the human and physical resources by inputting the usage and the utilization time of the human and physical resources included in each of a plurality of pieces of resource utilization plan information to the machine learning engine and performing machine learning so that a difference between the determined time to take countermeasures against the malfunction of the device and a time to take countermeasures determined by a person decreases.

4. The maintenance response time suggestion device according to claim 3, wherein the variation parameter is a rising period, a convergence period, and a maximum value of the usage amount of the human and physical resources.

5. The maintenance response time suggestion device according to claim 3, wherein the machine learning engine generates a pattern of the transition data of a resource usage amount of the human and physical resources for each usage of the human and physical resources.

6. The maintenance response time suggestion device according to claim 1, wherein the operations comprise:
determining a time to take countermeasures against the malfunction of the device, which is included in the predicted occurrence period of the malfunction of the device.

7. A maintenance response time suggestion method for suggesting a response time for preventive maintenance against malfunction of a device, the method causing a maintenance response time suggestion device to execute:
receiving sign detection information in which a sign of malfunction of the device is detected;
receiving resource utilization plan information that indicates a plan for a usage and a utilization time of human and physical resources related to a predicted occurrence period of the malfunction of the device;
estimating and calculating transition data of a usage amount of the human and physical resources related to the predicted occurrence period of the malfunction of the device by inputting the usage and the utilization time of the human and physical resources included in the resource utilization plan information to a machine learning engine that generates transition data of a usage amount of human and physical resources based on a usage and a utilization period of human and physical resources and performing machine learning; and
determining a time and a method for taking countermeasures against the malfunction of the device based on the sign detection information and the transition data of the usage amount of the human and physical resources.

8. A non-transitory computer readable medium storing one or more instructions causing a computer to execute operations comprising:
receiving sign detection information in which a sign of malfunction of a device is detected;
receiving resource utilization plan information that indicates a plan for a usage and a utilization time of human and physical resources related to a predicted occurrence period of the malfunction of the device;
estimating and calculating transition data of a usage amount of the human and physical resources related to the predicted occurrence period of the malfunction of the device by inputting the usage and the utilization time of the human and physical resources included in the resource utilization plan information to a machine learning engine that generates transition data of a usage amount of human and physical resources based on a usage and a utilization period of human and physical resources and performing machine learning; and
determining a time and a method for taking countermeasures against the malfunction of the device based on the sign detection information and the transition data of the usage amount of the human and physical resources.
